(19) United States
(12) Patent Application Publication
(10) Pub. No.: US 2026/0298163 A1
(43) Pub. Date: Oct. 1, 2026

(54) CONTROL APPARATUS FOR VEHICLE

(71) Applicant: TOYOTA JIDOSHA KABUSHIKI KAISHA, Toyota-shi (JP)

(72) Inventor: Akito UCHIDA, Toytoa-shi, Aichi-ken (JP)

(73) Assignee: TOYOTA JIDOSHA KABUSHIKI KAISHA, Toyota-shi (JP)

(21) Appl. No.: 19/566,265

(22) Filed: Mar. 13, 2026

(30) Foreign Application Priority Data
Mar. 25, 2025 (JP) 2025-050747

(51) Int. Cl. F02D 41/00; F02D 41/02

(52) U.S. Cl. CPC F02D 41/0007; F02D 41/0225; F02D 2250/21

(57) ABSTRACT

A control apparatus for executing at least one predetermined control related to running of a vehicle that is to run on a predetermined running route that is sectioned into a plurality of running sections. The control apparatus includes: (a) a receiving portion configured to receive input of a parameter which is related to operation of each of the at least one predetermined control and which is used for the plurality of running sections of the predetermined running route; and (b) a changing portion configured, when the vehicle enters a next one of the running sections from a current one of the running sections during running of the vehicle on the predetermined running route, to change the parameter from a current value to a next value that is to be used for the next one of the running sections.

This application claims priority from Japanese Patent Application No. 2025-050747 filed on Mach 25, 2025, the disclosure of which is herein incorporated by reference in its entirety.

### FIELD OF THE INVENTION

The present invention relates to a control apparatus for executing at least one predetermined control related to running of a vehicle.

### BACKGROUND OF THE INVENTION

There is known a control apparatus for executing at least one predetermined control related to running of a vehicle. For example, a vehicle control apparatus described in Patent Document 1 is such a control apparatus. Patent Document 1 discloses that a running mode is selected based on an average running speed calculated within a predetermined running time or a predetermined running distance. Patent Document 1 also discloses that control data defining a control specification of the vehicle for each running mode is stored, and that the control data corresponding to the running mode is acquired. Patent Document 1 also discloses that running on a race circuit and running on a standard road can be distinguished from each other based on the average running speed.

### PRIOR ART DOCUMENT

### Patent Document

[Patent Document 1] International Publication No. 2021/038710

### SUMMARY OF THE INVENTION

With a technique described in Patent Document 1, a running environment is estimated after the vehicle runs for a predetermined running time or by a predetermined running distance, and the vehicle control specification is switched according to the estimated running environment. Therefore, with the technique described in Patent Document 1, it is not possible to change the vehicle setting for each running area or course shape, for example, during running of the vehicle on a race circuit that circles a predetermined course.

The present invention was made against background of the above circumstances, and its purpose is to provide a control apparatus that is capable of switching a parameter related to operation of at least one predetermined control related to running of a vehicle even during running of the vehicle.

According to the present invention, there is provided a control apparatus for executing at least one predetermined control related to running of a vehicle that is to run on a predetermined running route that is sectioned into a plurality of running sections. The control apparatus includes: (a) a receiving portion configured to receive input of a parameter which is related to operation of each of the at least one predetermined control and which is used for the plurality of running sections of the predetermined running route; and (b) a changing portion configured, when the vehicle enters a next one of the running sections from a current one of the running sections during running of the vehicle on the predetermined running route, to change the parameter from a current value to a next value that is to be used for the next one of the running sections.

In the control apparatus according to the present invention, the input of the parameter which is related to operation of each of the at least one predetermined control and which is used for the plurality of running sections of the predetermined running route is received. When the vehicle enters the next one of the running sections from the current one of the running sections during running of the vehicle on the predetermined running route, the parameter is changed from the current value to the next value that is to be used for the next one of the running sections. Thus, when the vehicle enters the next running section, the parameter is changed to the next value that is suited to the next running section. Therefore, the parameter related to the operation of each of the at least one predetermined control can be changed even during running of the vehicle. Further, it is possible to obtain a secondary effect that is enabling the vehicle to run faster while reflecting user's intentions.

### BRIEF DESCRIPTION OF THE DRAWINGS

FIG. 1 is a view schematically showing a construction of a vehicle and a terminal unit to which the present invention is applied.

FIG. 2 is a view schematically showing a construction of an engine.

FIGS. 3A, 3B, 3C and 3D are views showing examples of various information displayed on a display, wherein FIG. 3A is an example when various information including a shift indicator is displayed, FIG. 3B is an example when a display pattern of the display is selected, FIG. 3C is an example when various information including a rotational speed meter displayed as a bar is displayed, and

FIG. 3D is an example when various information including a rotational speed meter displayed as a ring is displayed.

FIGS. 4A and 4B are views showing an example of execution of a predetermined control, wherein FIG. 4A is a view showing an example of a display screen when a control parameter is inputted to the terminal unit, and FIG. 4B is a view showing an example of a procedure for executing the predetermined control.

FIGS. 5A and 5B are views showing an example of a predetermined control executed in view of communication delay, wherein FIG. 5A is a view showing an example of a point at which a request for changing the control parameter is sent, and FIG. 5B is a view showing an example of a time chart when the predetermined control that takes the communication delay into account is executed.

FIGS. 6A and 6B are flowcharts showing main parts of control operations of the control apparatus, wherein FIG. 6A is a flowchart showing the control operation for setting the control parameter, and FIG. 6B is a flowchart showing the control operation for changing the control parameter during running of the vehicle.

### DETAILED DESCRIPTION OF PREFERRED EMBODIMENT

Hereinafter, a preferred embodiment of the present invention will be described in detail with reference to the drawings.

### Embodiment

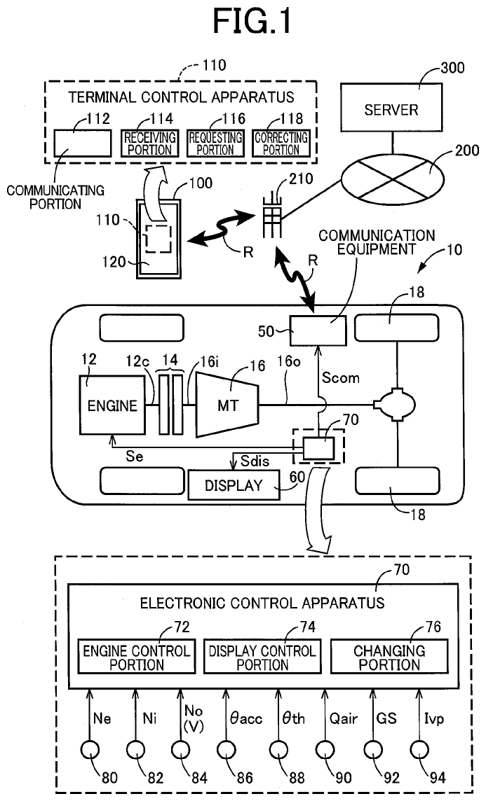

FIG. 1 is a view schematically showing a construction of a vehicle 10 and a terminal unit 100 to which the present invention is applied.

The vehicle 10 includes an engine 12, a clutch 14, a manual transmission 16 (see “MT” in FIG. 1) and drive wheels 18. The vehicle 10 further includes communication equipment 50, a display 60 and an electronic control apparatus 70.

The manual transmission 16 is provided in a power transmission path between the engine 12 and the drive wheels 18. The manual transmission 16 is, for example, a known synchronous mesh type parallel twin-shaft transmission in which a plurality of gear positions GS can be established. The manual transmission 16 is a transmission mounted on the vehicle 10 in the present invention.

The clutch 14 is, for example, a known dry single-plate friction clutch provided in a power transmission path between a crankshaft 12c of the engine 12 and an input shaft 16i of the manual transmission 16.

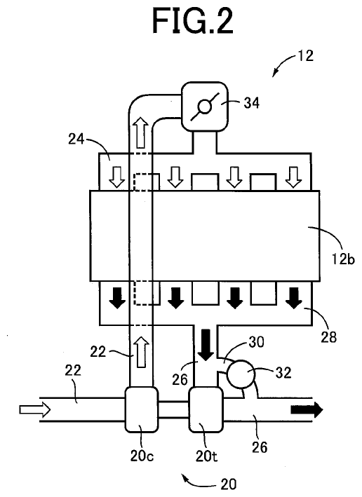

FIG. 2 is a view schematically showing a construction of the engine 12. The engine 12 is a known internal combustion engine having a turbocharger 20. An engine torque Te of the engine 12 is controlled by the electronic control apparatus 70. The engine 12 is an engine mounted on the vehicle 10 in the present invention.

An intake pipe 22 is provided in an intake system of the engine 12. The intake pipe 22 is connected to an intake manifold 24 attached to an engine body 12b. An exhaust system of the engine 12 is provided with an exhaust pipe 26. The exhaust pipe 26 is connected to an exhaust manifold 28 attached to the engine body 12b.

The turbocharger 20 is a known exhaust turbine type turbocharger having a compressor 20c provided in the intake pipe 22 and a turbine 20t provided in the exhaust pipe 26. An exhaust bypass 30, which is provided in parallel with the exhaust pipe 26, is provided with a known wastegate valve 32. An electronic throttle valve 34 is provided in the intake pipe 22 downstream of the compressor 20c and upstream of the intake manifold 24.

Referring back to FIG. 1, the communication equipment 50 exchanges various kinds of information with the electronic control apparatus 70 via, for example, a cable. The communication equipment 50 communicates with a server 300 via a known network 200 that is located outside the vehicle 10 so as to exchange the various kinds of information. The communication equipment 50 is connected to the network 200 via a wireless communication R with, for example, a wireless device 210 that is located outside the vehicle 10. The wireless device 210 is a transmitting/receiving device connected to the network 200, and transmits and receives various signals via the wireless communication R.

The server 300 is an external control apparatus constructed by, for example, a manufacturer of the vehicle 10, and is provided apart from the vehicle 10 and the terminal unit 100. The server 300 is a computer equipped with a CPU and the like, and is connected to the network 200. The server 300 is connected to each of the vehicle 10 and the terminal unit 100 via the wireless communication R. The server 300 is a device that receives, processes, analyzes, stores and provides the various kinds of information.

The display 60 is a display device that displays the various kinds of information to a driver of the vehicle 10, for example. The display 60 is disposed, for example, in front of a driver's seat of the vehicle 10.

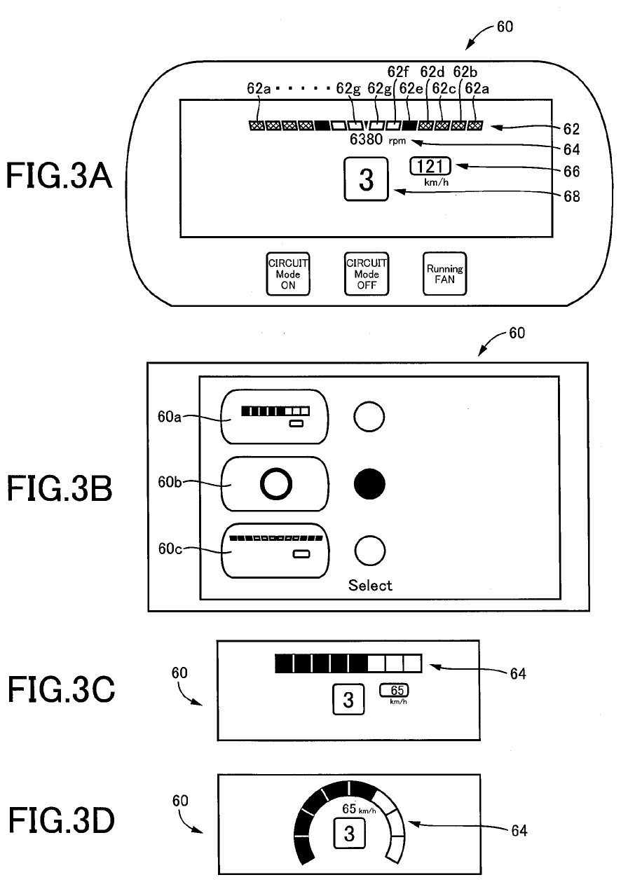

FIGS. 3A, 3B, 3C and 3D are views showing examples of various information displayed on the display 60, wherein FIG. 3A is an example when various information including a shift indicator 62 is displayed, FIG. 3B is an example when a display pattern of the display 60 is selected, FIG. 3C is an example when various information including a rotational speed meter 64 displayed as a bar is displayed, and FIG. 3D is an example when various information including the rotational speed meter 64 displayed as a ring is displayed.

In FIG. 3A, the display 60 displays, for example, the shift indicator 62, the rotational speed meter 64, a running speed meter 66 and a gear position indicator 68. The shift indicator 62 is an example of an indicator that indicates a timing at which the driver shifts the manual transmission 16. The shift indicator 62 indicates a shift timing of the manual transmission 16. The shift indicator 62 indicates the shift timing, for example, by lighting a plurality of lighting areas (62a to 62g) that are arranged consecutively. The lighting areas (62a to 62g) extend in sequence from opposite ends of the display areas (62a to 62g) toward center ones of the display areas (62a to 62g) as the shift timing approaches, and reach the center ones at the shift timing. The lighting areas (62a to 62g) are controlled to turn ON and OFF based on the engine rotational speed Ne.

The rotational speed meter 64 is an example of a meter that indicates the engine rotational speed Ne. The running speed meter 66 is an example of a meter that indicate the running speed V of the vehicle 10. The gear position indicator 68 is an example of an indicator that indicates the gear position GS of the manual transmission 16.

As shown in FIG. 3B, the display patterns of the display 60 can be selected in the vehicle 10. For example, the selectable display patterns are a display pattern 60a that displays the rotational speed meter 64 as a bar, a display pattern 60b that displays the rotational speed meter 64 as a ring and a display pattern 60c that displays the shift indicator 62. FIG. 3A shows an example of the display pattern 60c that displays the shift indicator 62. The display pattern 60c is a display pattern that is be used when, for example, a circuit mode (described later) is turned ON. FIG. 3C shows an example of the display pattern 60a that displays the rotational speed meter 64 as a bar. FIG. 3D shows an example of the display pattern 60b that displays the rotational speed meter 64 as a ring.

Referring back to FIG. 1, the electronic control apparatus 70 is a controller that executes various controls in the vehicle 10. The electronic control apparatus 70 is configured to include, for example, a so-called microcomputer equipped with CPU, RAM, ROM and input/output interface. The electronic control apparatus 70 executes various controls in the vehicle 10 by, for example, utilizing a temporary storage function of the RAM and causing the CPU to process signals in accordance with programs previously stored in the ROM.

Various signals based on detection signals from various sensors provided in the vehicle 10 are inputted to the electronic control apparatus 70. The various sensors include, for example, an engine rotational-speed sensor 80, an input rotational-speed sensor 82, an output rotational-speed sensor 84, an acceleration opening-degree sensor 86, a throttle-valve opening-degree sensor 88, an air flow meter 90, a gear position sensor 92 and a vehicle location sensor 94. The various signals include, for example, an engine rotational speed Ne, an input rotational speed Ni, an output rotational speed No, an accelerator opening degree θacc, a throttle-valve opening degree θth, an intake air amount Qair, a gear position GS and location information Ivp.

The input rotational speed Ni is a rotational speed of the input shaft 16i. The output rotational speed No is a rotational speed corresponding to the running speed V and is a rotational speed of an output shaft 16o of the manual transmission 16. The accelerator opening degree θacc is an amount of accelerator operation by the driver, which indicates a magnitude of the driver's acceleration/deceleration operation. The throttle-valve opening degree θth is an opening degree of the electronic throttle valve 34. The vehicle location sensor 94 includes a GPS (Global Positioning System) antenna. The location information Ivp is information indicating a current vehicle location VP on a ground or on a map based on GPS signals (orbital signals) transmitted by GPS satellites and the like. The vehicle location VP is a location of the vehicle 10. Unless otherwise specified, the vehicle location VP indicates the current vehicle location VP. The gear position GS of the manual transmission 16 may de estimated based on a gear ratio (=Ni/No) that is calculated from the input rotational speed Ni and the output rotational speed No. In this case, the gear position sensor 92 is not required.

The electronic control apparatus 70 outputs various command signals to various devices provided in the vehicle 10. The various devices are, for example, the engine 12 and the display 60. The various command signals are, for example, an engine-control command signal Se and an information-display command signal Sdis. The engine-control command signal Se is a command signal for controlling the output of the engine 12 and executing an anti-lag control CNaI. The information-display command signal SDis is a command signal for displaying various information such as the engine rotational speed Ne on the display 60.

The electronic control apparatus 70 transmits and receives a communication signal Scom to and from the communication equipment 50. The communication signal Scom contains various information exchanged between the electronic control apparatus 70 and the communication equipment 50, such as location information Ivp and setting information transmitted from the terminal unit 100.

The electronic control apparatus 70 includes an engine control portion 72 and a display control portion 74 so as to executes the various controls in the vehicle 10.

The engine control portion 72 outputs the engine-control command signal Se so as to control the output of the engine 12, for example, by controlling the electronic throttle valve 34, a fuel injection amount and an ignition timing, based on the accelerator opening degree θacc.

In the engine 12 having the turbocharger 20, a supercharging response delay (so-called turbo lag) may occur, for example, in a re-accelerating by accelerator ON after deceleration with accelerator OFF. The engine control portion 72 outputs an engine-control command signal Se so as to execute the anti-lag control CNal for suppressing the supercharging response delay. The engine control portion 72 executes the anti-lag control CNal, for example, when the accelerator opening degree θacc is changed from a state in which the accelerator opening degree θacc is equal to or higher than a predetermined high degree θacchf to a state in which the accelerator opening degree θacc is equal to or lower than a predetermined low degree θacclf. The predetermined low degree θacclf is a lower value than the predetermined high degree θacchf. The predetermined high degree θacchf and the predetermined low degree θacclf are predetermined thresholds for determining that it is necessary to suppress the supercharging response delay. In the anti-lag control CNal, for example, the engine control portion 72 inhibits a fuel cut and keeps the wastegate valve 32 fully closed. In the anti-lag control CNal, for example, the intake air amount Qair of the engine 12 is increased by a predetermined amount Qf as compared to when the anti-lag control CNal is not executed. The predetermined amount Qf is a predetermined increase amount in the intake air amount Qair, which allows the turbocharger 20 to maintain a supercharging state, for example. This maintains the supercharging state of the turbocharger 20, thereby suppressing the supercharging response delay in the re-accelerating by the accelerator ON after deceleration with the accelerator OFF. Increasing the intake air amount Qair leads to an increase in the engine torque Te. In the anti-lag control CNal, the engine control portion 72 controls the ignition timing of the engine 12 to a retard side by an amount corresponding to the predetermined amount Qf. In the anti-lag control CNal, the engine control portion 72 retards the ignition timing according to the accelerator opening degree θacc. The anti-lag control CNal is a control for suppressing the supercharging response delay while causing the engine 12 to output the torque in response to the accelerator operation. The anti-lag control CNal is one of the predetermined controls CNf related to running of the vehicle 10 in the present invention. The electronic control apparatus 70 corresponds to a control apparatus of the present invention, and executes at least one predetermined control CHf related to running of the vehicle 10.

A strength of effect of the anti-lag control CNal, i.e., a strength of anti-lag level AL, can be changed, for example, by the predetermined amount Qf. The anti-lag level AL is a parameter related to operation of the anti-lag control CNal. The anti-lag level AL is a value that determines a degree to which the supercharging response delay is to be suppressed. The anti-lag level AL is set to a strength such as “high”, “medium” or “low”. The strength of the anti-lag level AL is synonymous with the strength of the degree to which the supercharging response delay is to be suppressed. As will be described later, the anti-lag level AL is set to the strength desired by the user via the terminal unit 100. The higher the predetermined amount Qf, the higher the anti-lag level AL. When the engine control portion 72 executes the anti-lag control CNal, the higher the parameter of the anti-lag level AL is, the higher the predetermined amount Qf is set.

The display control portion 74 outputs the information-display command signal Sdis so as to display various information such as the engine rotational speed Ne, the running speed V and the gear position GS on the display 60.

The display control portion 74 outputs the information-display command signal Sdis so as to control the lighting areas (62a to 62g) of the display 60 for lighting up in sequence from opposite end ones of the lighting areas (62a to 62g) toward center ones of the lighting areas (62a to 62g) as the shift timing approaches, and so as to control all of them to light up at the shift timing. When all of the lighting areas (62a to 62g) are illuminated, it is considered to be the timing of the shift operation of the manual transmission 16. For example, when the manual transmission 16 is upshifted, the display control portion 74 lights up the lighting areas (62a to 62g) in sequence, from the lighting areas 62a toward the lighting areas 62g, as the engine rotational speed Ne is increased. Threshold values of the engine rotational speed Ne at which the lighting areas (62a to 62g) are illuminated are set, for example, to be evenly spaced. In this case, the threshold value of the engine rotational speed Ne at which the lighting areas 62a are illuminated is set to be smaller than the threshold value of the engine rotational speed Ne at which the lighting areas 62g are illuminated. The threshold value of the engine rotational speed Ne at the same lighting areas (62a to 62f) is set to be smaller as the gear position GS of the manual transmission 16 is lower (first gear side). The threshold value of the engine rotational speed Ne at which the lighting areas 62g corresponding to shift timing are illuminated, i.e., a shift-timing rotational speed Nest, is set to the same value for all of the gear position GS. The display control portion 74 executes a shift indicator control CNsi, which displays the timing of the shift operation of the manual transmission 16. The shift indicator control CNsi is one of the predetermined controls CNf related to running of the vehicle 10 in the present invention.

The shift-timing rotational speed Nest is one of the parameters, which is related to the operation of the shift indicator control CNsi. The shift-timing rotational speed Nest is one of the values related to a display form of the timing of the shift operation. The shift-timing rotational speed Nest is set to the value desired by the user via the terminal unit 100, as described below. timing is approaching and prompts him or her to prepare for the shift operation. The time from when the lighting areas 62a are illuminated to when the lighting areas 62g are illuminated, i.e., a shift preparation time TMr, is one of the parameters related to the operation of the shift indicator control CNsi. The shift preparation time TMr is one of the values related to the display form of the timing of the shift operation. The shift preparation time TMr is set to a value desired by the user via the terminal unit 100, as will be described later. For the same gear position GS, the threshold value of the engine rotational speed Ne at which the lighting areas 62a are illuminated is set to a lower value as the shift preparation time TMr is longer.

The terminal unit 100 is, for example, a dedicated operation terminal, a known personal computer, a known tablet, a known smartphone or other portable terminal. The terminal unit 100 includes, for example, a terminal control apparatus 110 and a display 120. The display 120 is, for example, a touch panel that allows touch input.

The terminal control apparatus 110 is a controller that executes various controls in the terminal unit 100. The terminal control apparatus 110 includes, for example, a so-called microcomputer provided with CPU, RAM, ROM and input/output interface. The terminal control apparatus 110 executes the various controls in the terminal unit 100 by, for example, utilizing the temporary storage function of the RAM and causing the CPU to process signals in accordance with programs previously stored in the ROM.

The terminal control apparatus 110 includes a communicating portion 112 and a receiving portion 114 so as to execute the various controls in the terminal unit 100.

The communicating portion 112 includes a transmitting/receiving device (not shown) connected to the network 200 via the wireless communication R with the wireless device 210. The communicating portion 112 communicates with the server 300 via the network 200 to exchange various information. The vehicle 10 and the terminal unit 100 exchange the various information via the server 300, for example. The terminal unit 100 is a terminal unit through which the information is transmitted and received via communication with the vehicle 10. The terminal unit 100 is a terminal unit provided apart from the vehicle 10 in the present invention.

The receiving portion 114 accepts input of control parameters VLcn, i.e., parameters related to the operation of the predetermined controls CNf (such as the anti-lag control CNal and the shift indicator control CNsi). The receiving portion 114 accepts input of, for example, the anti-lag level AL, the shift-timing rotational speed Nest and the shift preparation time TMr by the user. For example, the receiving portion 114 displays a screen on the display 120 for setting each of the anti-lag level AL, the shift-timing rotational speed Nest and the shift preparation time TMr, and accepts input of each of the control parameters VLcn. The terminal control apparatus 110 is involved in execution of the predetermined controls CNf. The terminal control apparatus 110 corresponds to a control apparatus of the present invention, and executes at least one predetermined control CHf related to running of the vehicle 10.

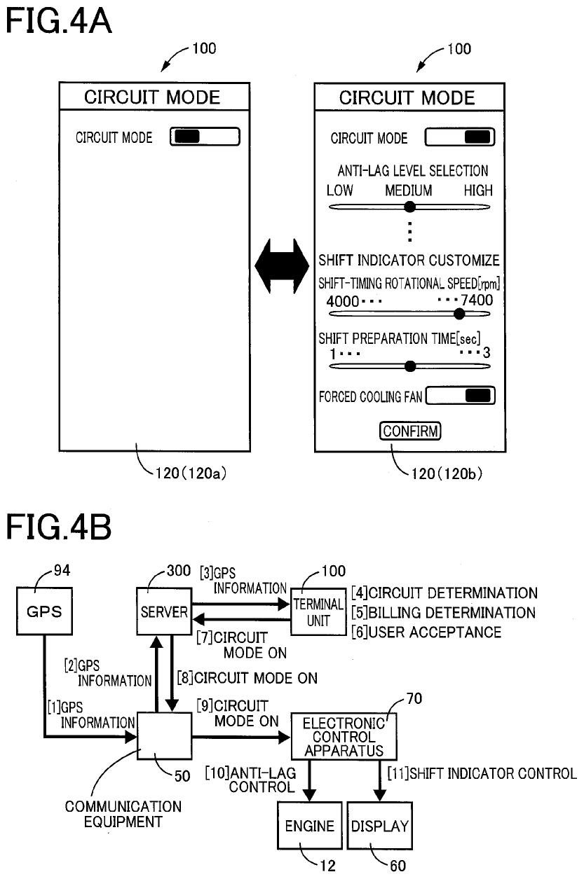

FIGS. 4A and 4B are views showing an example of execution of the predetermined control CNf, wherein FIG. 4A is a view showing an example of a screen of the display 120 when the control parameter VLcn is inputted to the terminal unit 100, and FIG. 4B is a view showing an example of a procedure for executing the predetermined control CNf.

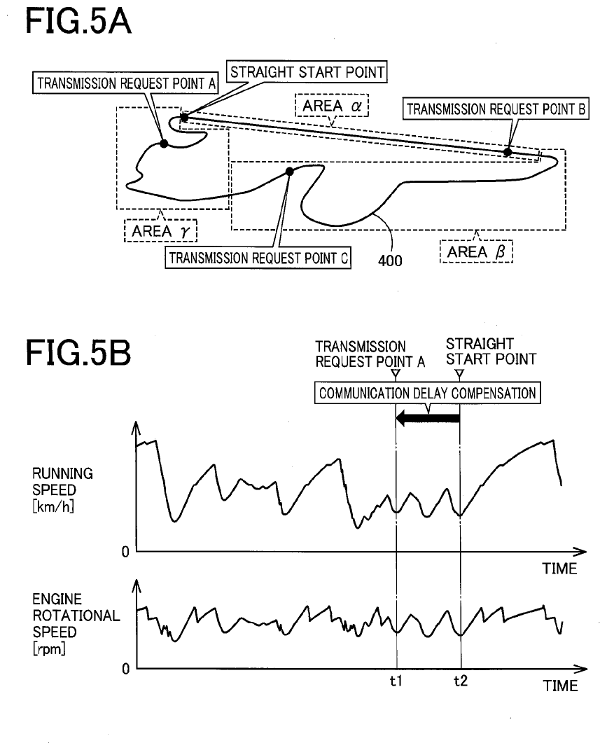

As shown in FIG. 4A, the predetermined control CNf is executed when the vehicle 10 is driven, for example, on a known race circuit 400 (see FIG. 5A described later). The receiving portion 114 displays a screen on the display 120 (see 120a) for accepting a mode for executing the predetermined control CNf, for example, whether or not to enable the circuit mode. When the circuit mode is enabled, the receiving portion 114 displays the screen on display 120 for accepting input of the control parameter VLcn (see 120b). The display 120b displays a screen for accepting, for example, selection of the anti-lag level AL, setting of the shift-timing rotational speed Nest and the setting of the shift preparation time Trmr, for example.

In FIG. 4B, the location information Ivp output from the vehicle location sensor 94, i.e., GPS information indicating the vehicle location VP, is transmitted to the terminal unit 100 via the communication equipment 50 and the server 300 (see [1], [2], [3]). The terminal unit 100 determines, for example, based on the GPS information, whether the vehicle location VP is located on the race circuit 400, and determines a user's contract status so as to determine whether to accept the user (see [4], [5], [6]). When the terminal unit 100 accepts the user, if the circuit mode is enabled, the terminal unit 100 transmits signals indicative of a “circuit mode ON” and the control parameter VLcn to the server 300 (see [7]). The signals indicative of a “circuit mode ON” and the control parameter VLcn are transmitted to the electronic control apparatus 70 via the server 300 and the communication equipment 50 (see [8], [9]). The electronic control apparatus 70 outputs the engine-control command signal Se that executes the anti-lag control CNal when the vehicle 10 runs on the race circuit 400 (see [10]). The electronic control apparatus 70 outputs the information-display command signal Sdis that executes the shift indicator control CNsi when the vehicle 10 runs on the race circuit 400 (see [11]).

The control parameter VLcn, which is set by the user beforehand using the terminal unit 100 prior to running of the vehicle 10, is preferably changed during running of the vehicle 10 on the race circuit 400. For example, the control parameter VLcn is preferably changed for each of the multiple running sections AR into which the race circuit 400 is sectioned, such as for each corner or sector. Being able to change the control parameter VLcn for each corner or sector is expected to lead to improved lap times and stable sports driving. A system is established that allows the control parameter VLcn to be changed even during running of the vehicle 10 while ensuring safety. For this purpose, the electronic control apparatus 70 further includes a changing portion 76. The race circuit 400 is a predetermined running route in the present invention.

The receiving portion 114 receives input of the control parameter VLcn used for the plurality of running sections AR into which the race circuit 400 is sectioned. One of the running sections AR is, for example, a section of the running route that is mainly a straight course (see “area α” in FIG. 5A). Another of the running sections AR is, for example, a section of the running route that has corners built into a short straight course (see “area β” in FIG. 5A). Still another of the running sections AR is, for example, a section of the running route that has corners built into a course that is mainly curved (see “area γ” in FIG. 5A). For example, it may be safer and faster to execute a shift operation before each corner rather than in a middle of each corner. Therefore, it is considered that there is a need to change the shift-timing rotational speed Nest in the areas β and γ as compared to the area α.

For example, in running through the running sections AR of the race circuit 400 in order, when the vehicle 10 enters a next one of the running sections AR, the changing portion 76 changes the control parameter VLcn from a current value to a next value that is to be used in the next running section AR.

Where the control parameter VLcn is transmitted from the terminal unit 100 to the vehicle 10 each time the vehicle 10 enters the next running section AR, at least the communication time of the GPS information indicating the vehicle location VP and the communication time of the control parameter VLcn are required. Therefore, it is necessary to grasp the vehicle location VP and take into consideration the communication delay until the control parameter VLcn from the terminal unit 100 reaches the vehicle 10. The communication delay is synonymous with the delay in transmitting information via communication. It is noted that, taking into consideration the occurrence of the communication delay, if the prerequisite for enabling the circuit mode is that the vehicle 10 is being stopped, the control parameter VLcn is not changed during running of the vehicle 10 on the race circuit 400. The present invention is a technique for appropriately changing the control parameter VLcn while the vehicle 10 is running on the race circuit 400, even if the communication delay occurs. In the present invention, the prerequisite for enabling the circuit mode does not include the vehicle being stopped.

FIGS. 5A and 5B are views showing an example of the predetermined control CNf executed in view of the communication delay, wherein FIG. 5A is a view showing an example of a point at which a request for changing the control parameter VLcn is sent, and FIG. 5B is a view showing an example of a time chart when the predetermined control CNf that takes the communication delay into account is executed.

A shown in FIG. 5A, the vehicle 10 repeatedly travels through the areas α, β and γ in the race circuit 400 in this order. When the terminal unit 10 recognizes, based on the GPS information included in the information transmitted from the vehicle 10, that the vehicle 10 has reached a transmission request point A before entering the area α, the terminal unit 10 transmits, to the vehicle 10, a value of the control parameter VLcn to be used in the area α. Transmitting a next value of the control parameter VLcn to the vehicle 10 to be used in the next running section AR is equivalent to transmitting, to the vehicle 10, a request to change the control parameter VLcn from a current value to the next value. The vehicle 10 changes the control parameter VLcn from the current value to the next value which has been transmitted from the terminal unit 100. The value of the control parameter VLcn used in the area α is transmitted from the terminal device 100 at a timing that takes the communication delay into consideration (see time point t1 in FIG. 5B). The control parameter VLcn used in the predetermined control CNf is changed to the value used in the area α when the current location of the vehicle 10 reaches a start point of the area α (see “STRAIGHT START POINT”) (see time point t2 in FIG. 5B). A value of the control parameter VLcn used in the area β and a value of the control parameter VLcn used in the area γ are also transmitted from the terminal unit 100 at points that take the communication delay into consideration (see “transmission Request Point B” and “transmission Request Point C” in FIG. 5A).

To this end, the terminal unit 100 further includes a requesting portion 116. When the vehicle location VP included in the information transmitted from the vehicle 10 during the running on the race circuit 400 reaches a predetermined preparation point VPf, the requesting portion 116 transmits, to the changing portion 76, the control parameter VLcn to be used in the next running section AR where the vehicle 10 is going to enter. The predetermined preparation point Vpf is on a front side of the start point of the next running section AR by a distance corresponding to the communication delay, i.e., delay of transmission of the information via the communication. The predetermined preparation point Vpf, which is on the front side of the start point of the next running section AR, is synonymous with the vehicle location VP in the current running section AR in which the vehicle 10 is currently running, before entering the next running section AR. The predetermined preparation point Vpf is a transmission request point at which the requesting portion 116 transmits a request to change the control parameter VLcn to the vehicle 10. The changing portion 76 changes the control parameter VLcn from the current value to the next value which has been sent from the requesting portion 116.

For example, during the running on the race circuit 400 for the first time, a predetermined initial value is used for the predetermined preparation point Vpf, taking into consideration the communication delay and a shape (running route) of the race circuit 400. For example, during the running on the race circuit 400 for the second and subsequent times, a value corrected in advance based on driving data for the race circuit 400 is used as the predetermined preparation point Vpf. This corrected value is, for example, a value corrected such that the control parameter VLcn is changed at the start point of the running section AR. The driving data for the race circuit 400 is, for example, data indicative of a time difference between a time point at which the vehicle location VP reaches the currently used predetermined preparation point Vpf and a time point at which the control parameter VLcn is changed from the current value to the next value transmitted from the terminal unit 100. This data indicative of the above-described time difference corresponds to a history of the communication delay during the running on the race circuit 400, for example. The driving data for the race circuit 400 may be, for example, data indicative of a positional difference between the actual vehicle location VP when the control parameter VLcn is changed from the current value to the next value transmitted from the terminal unit 100 and the start point of the next running section AR. This data indicative of the above-described positional difference corresponds to a difference between the expected communication delay and the actual communication delay. Therefore, this data indicative of the positional difference corresponds to, for example, the history of the communication delay during the running on the race circuit 400. The running on the race circuit 400 for the second and subsequent times includes, for example, the running on the race circuit 400 for the second or subsequent laps.

To this end, the terminal unit 100 further includes a correcting portion 118. The correcting portion 118 corrects the predetermined preparation point Vpf based on the communication delay history recorded during the running on the race circuit 400. For example, where the communication delay history is data indicative of the time difference, the correcting portion 118 calculates the vehicle location VP in which the vehicle 10 is located at a time point that goes back by the time difference from the start point of the next running section AR. The correcting portion 118 changes the predetermined preparation point Vpf to the calculated vehicle location VP. The correcting portion 118 corrects the predetermined preparation point Vpf by performing a reverse calculation from the driving data on the race circuit 400 transmitted from the electronic control apparatus 70.

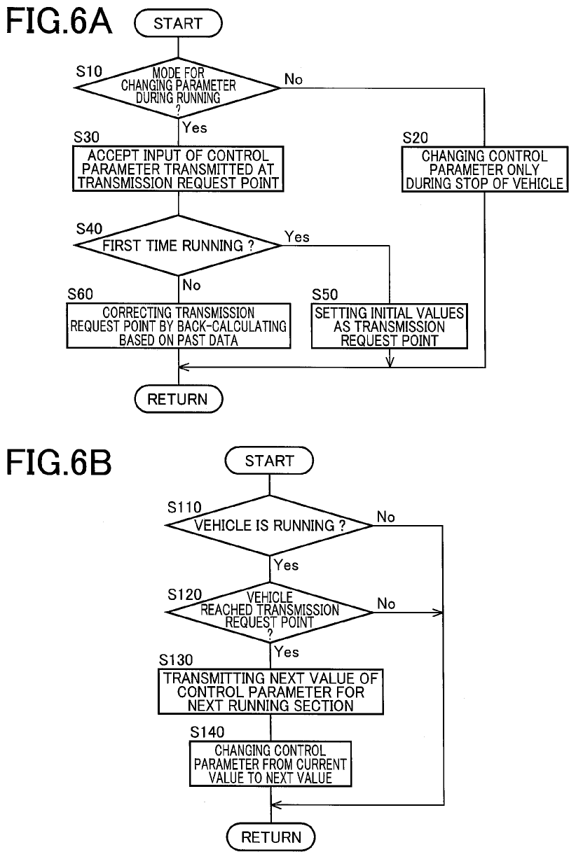

FIGS. 6A and 6B are flowcharts showing main parts of control operations of the control apparatus (the electronic control apparatus 70 and the terminal control apparatus 110), wherein FIG. 6A is a flowchart showing a control routine for setting the control parameter VLcn, and FIG. 6B is a flowchart showing a control routine for changing the control parameter VLcn during running of the vehicle 10. Each of the control routines of FIGS. 6A and 6B can be executed even during the running of the vehicle 10, and is executed in a repeated manner.

The control routine shown by the flow chart of FIG. 6A is initiated with step S10 corresponding to function of the receiving portion 114, which is implemented to determine whether the circuit mode is enabled, namely, whether a mode allowing change of the control parameter VLcn during the running is enabled. When a negative determination is made at step S10, the control flow goes to step S20 corresponding to function of the requesting portion 116. At step S20, the control parameter VLcn is changed only while the vehicle 10 is being stopped. When an affirmative determination is made at step S10, step S30 corresponding to function of the receiving portion 114 is implemented to accept the input of the control parameter VLcn transmitted at each predetermined preparation point Vpf (transmission request point). Next, at step S40 corresponding to function of the correcting portion 118, it is determined whether this is the first time that the vehicle 10 is running on a predetermined running route (e.g., race circuit 400) in which the control parameter VLcn is changed during the running. When an affirmative determination is made at step S40, the control flow goes to step S50 corresponding to function of the correcting portion 118, which is implemented to set an initial values as each predetermined preparation point Vpf. When a negative determination is made at step S40, step S60 corresponding to function of the correcting portion 118 is implemented to correct the predetermined preparation point Vpf (transmission request point) by back-calculating based on the driving data of the predetermined running route.

The control routine shown by the flow chart of FIG. 6B is initiated with step S110 corresponding to function of the requesting portion 116, which is implemented to determine whether the vehicle 10 is running on the predetermined running route (e.g., race circuit 400). When a negative determination is made at step S110, one cycle of execution of the control routine is terminated. When an affirmative determination is made at step S110, step S120 corresponding to function of the requesting portion 116 is implemented to determine whether the vehicle location VP has reached the predetermined preparation point Vpf. When a negative determination is made at step S120, one cycle of execution of the control routine is terminated. When an affirmative determination is made at step S120, step S130 corresponding to function of the requesting portion 116 is implemented to transmit the next value of the control parameter VLcn which is to be used in the next running section AR. Next, at step S140, which corresponds to function of the changing portion 76, the control parameter VLcn is changed from the current value to the transmitted next value.

As described above, according to the present embodiment, the input of the parameter VLcn which is related to operation of each of the at least one predetermined control CNf and which is used for the plurality of running sections AR of the predetermined running route is received. When the vehicle 10 enters the next one of the running sections AR from the current one of the running sections AR during running of the vehicle 10 on the predetermined running route, the control parameter VLcn is changed from the current value to the next value that is to be used for the next one of the running sections AR. Thus, when the vehicle 10 enters the next running section AR, the control parameter VLcn is changed to the next value that is suited to the next running section AR. Therefore, the control parameter VLcn related to the operation of each of the at least one predetermined control CNf can be changed even during running of the vehicle 10. Further, it is possible to obtain a secondary effect that is enabling the vehicle 10 to run faster while reflecting user's intentions. For example, by customizing for each corner or section, it is possible to enable the vehicle 10 to run the race circuit 400 faster. It is also possible to provide an unprecedented experience value.

According to this embodiment, when the vehicle location VP included in the information transmitted from the vehicle 10 during the running on the predetermined running route reaches the predetermined preparation point Vpf, the next value of the control parameter VLcn to be used in the next running section AR is transmitted from the terminal unit 100 to the vehicle 10. The control parameter VLcn is changed from the current value to the next value that has been transmitted from the terminal unit 100. In this way, the control parameter VLcn is changed by taking into account the communication delay.

According to this embodiment, the predetermined preparation point Vpf is corrected based on the history of the communication delays during the running on the predetermined running route. As a result, the control parameter VLcn is changed at a timing suitable in view of the communication delay.

According to this embodiment, the control parameter VLcn related to the operation of the shift indicator control CNsi is the shift-timing rotational speed Nest or the shift preparation time Tmr. This makes it easier for the driver to perform a shift operation, thereby enabling the vehicle 10 to run faster.

According to this embodiment, the control parameter VLcn related to the operation of the anti-lag control CNal is the anti-lag level AL. This makes it easier to output the power required by the driver, thereby enabling the vehicle 10 to run faster.

Although the embodiment of the present invention has been described in detail above with reference to the drawings, the present invention can also be applied to other embodiments.

For example, in the above-described embodiment, the receiving portion 114 may be provided in the electronic control apparatus 70. In this case, a certain effect can be obtained, that is, the control parameter VLcn can be changed even during running of the vehicle 10. In this case, the terminal unit 100 is not required, and there is no need to consider communication delay. Alternatively, the requesting portion 116 may be provided in the server 300 (external control apparatus), and the correcting portion 118 may be provided in the server 300 or the electronic control apparatus 70. In this case, the server 300 is a control apparatus of the present invention, and executes the predetermined control or controls CNf.

In the above-described embodiment, the predetermined control CNf may be a display-color change control that changes a display color of the display 60. In this display-color change control, for example, during the running on the race circuit 400, the shift indicator 62 may be displayed in a color different from that of the areas α and β in the area γ. Alternatively, the predetermined control CNf may be a display-pattern change control that changes the display pattern of the display 60.

In the above-described embodiment, the predetermined running route is not limited to the race circuit 400, as long as it can be sectioned into a plurality of running sections.

In addition, in the above-described embodiment, the transmission may be an automatic transmission that allows manual gear shifting by operating a lever or paddle.

It should be noted that the above is merely one embodiment, and the present invention can be embodied in various forms with various modifications and improvements based on the knowledge of those skilled in the art.

### NOMENCLATURE OF ELEMENTS

10: vehicle
12: engine
16: manual transmission
20: turbocharger
70: electronic control apparatus (control apparatus)
76: changing portion
100: terminal unit
110: terminal control apparatus (control apparatus)
114: receiving portion
116: requesting portion
118: correcting portion

What is claimed is:

1. A control apparatus for executing at least one predetermined control related to running of a vehicle that is to run on a predetermined running route that is sectioned into a plurality of running sections,
the control apparatus comprising:
a receiving portion configured to receive input of a parameter which is related to operation of each of the at least one predetermined control and which is used for the plurality of running sections of the predetermined running route; and
a changing portion configured, when the vehicle enters a next one of the running sections from a current one of the running sections during running of the vehicle on the predetermined running route, to change the parameter from a current value to a next value that is to be used for the next one of the running sections.

2. The control apparatus according to claim 1,
wherein the receiving portion is disposed in a terminal unit which is provided apart from the vehicle and which is configured to transmit and receive information to and from the vehicle via communication,
wherein the changing portion is disposed in the vehicle,
wherein the terminal unit includes a requesting portion configured to transmit, to the changing portion, the next value of the parameter which is to be used for the next one of the running sections, when a current location of the vehicle included in the information transmitted from the vehicle during the running on the predetermined running route reaches a predetermined preparation point that is on a front side of a start point of the next one of the running sections by a distance corresponding to a delay of transmission of the information via the communication, and
wherein the changing portion is configured to change the parameter from the current value to the next value that is transmitted from the requesting portion.

3. The control apparatus according to claim 2, further comprising a correcting portion configured to correct the predetermined preparation point based on a history of the delay of the transmission of the information recorded during the running of the vehicle on the predetermined running route.

4. The control apparatus according to claim 1,
wherein the at least one predetermined control includes a shift indicator control that is to be executed to indicate a timing of a shift operation of a transmission provided in the vehicle, and
wherein the parameter related to the operation of the shift indicator control is related to a display form of the timing.

5. The control apparatus according to claim 1,
wherein the at least one predetermined control includes an anti-lag control that is to be executed, in control of an engine having a turbocharger and included in the vehicle for causing the engine to output a torque in accordance with an accelerator operation, to suppress a delay of response of supercharging of the turbocharger, and
wherein the parameter related to the operation of the anti-lag control defines a degree to which the delay of the response of the supercharging is to be suppressed in the anti-lag control.
